(19) United States
(12) Patent Application Publication
(10) Pub. No.: US 2023/0086061 A1
(43) Pub. Date: Mar. 23, 2023

(54) DYNAMIC EVENT-TRIGGERED UPDATES FOR NETWORK-BASED SERVICES

(71) Applicant: Uber Technologies, Inc., San Francisco, CA (US)

(72) Inventors: Ankit Srivastava, San Francisco, CA (US); Karo Shaginyan, San Francisco, CA (US)

(21) Appl. No.: 17/482,137

(22) Filed: Sep. 22, 2021

(51) Int. Cl. G06Q 10/08; G06Q 30/00; G01C 21/00; G01C 21/34

(52) U.S. Cl. CPC G06Q 10/0833; G06Q 30/016; G01C 21/3889; G01C 21/3415; G01C 21/3492

(57) ABSTRACT

A network system can match a service provider with multiple service requests. The network system can further determine a service plan that indicate an ordered sequence of service locations for the service provider in fulfilling the multiple service requests. A route can be determined for the service provider based on the service plan. While the service provider is in-progress of fulfilling the multiple service requests, the network system can detect a service plan update event. In response to detecting the service plan update event, the network system can update the service plan of the service provider, including determining a different order of service locations for the service provider. An updated route can be generated for the service provider based on the updated service plan.

### BACKGROUND

A network-based service can enable users to request and receive various services through applications on mobile computing devices. The network-based service can match a service provider with a requesting user based on the current location of the service provider and a start location specified by the requesting user or determined based on the current location of the requesting user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system managing a network-based service, in accordance with examples described herein;

FIG. 2A to 2B illustrate examples for dynamically updating service plans and routes in response to detecting service plan update events, in accordance with the examples described herein;

FIG. 3 is a flowchart diagram illustrating an example method of dynamically updating a service plan in response to detected events, in accordance with examples described herein;

FIG. 4 is a block diagram illustrating an example user device executing and operating a designated user application for communicating with a network system, according to examples described herein;

FIG. 5 is a block diagram illustrating an example service provider device executing and operating a designated service provider application for communicating with a network service, according to examples described herein; and

FIG. 6 is a block diagram that illustrates a computer system upon which examples described herein may be implemented.

### DETAILED DESCRIPTION

A network system is provided herein that manages a network-based service (e.g., a transport service, a delivery or courier service, etc.) linking available service providers with requesting users throughout a given region (e.g., a metroplex such as the San Francisco Bay Area). In doing so, the network system can receive service requests for on-demand services from requesting users via a designated service requester application executing on the users' mobile computing devices. Based on a location associated with the requesting user (e.g., a current location, an indicated start or rendezvous location), the network system can identify a number of available service providers (e.g., a driver, a courier, etc.) and transmit a service invitation to one or more provider devices of the available service providers to fulfil the service request. The provider devices of the service providers receiving the invitations can present content that allows the service providers to either accept or decline the invitation.

In identifying a service provider to fulfill a given service request, the network system can identify a service provider based, at least in part, on a start location indicated in the service request. For example, the network system can determine a geo-fence surrounding the start location (or an area defined by a radius distance away from the start location), identify a set of candidate service providers (e.g., twenty or thirty service providers within the geo-fence or area), and select an optimal service provider (e.g., closest service provider to the service location, service provider with the shortest estimated travel time from the service location, service provider traveling to a location within a specified distance or specified travel time to the destination location, etc.) from the candidate service providers to fulfill the service request. According to examples provided herein, the network system can compile historical data for individual service requesters with regard to the network-based service. Thus, the network system can manage a service requester profile for each service requester indicating routine start and/or end locations (or regions), and/or routine routes (e.g., for a transportation service from home to work and/or vice versa) and preferred service types (e.g., transportation, delivery, mailing, etc.). In some examples, the network system can further synchronize with a service requester device to, for example, identify the service requester's contacts, the service requester's schedule and appointments, travel plans (e.g., a scheduled trip), and the like.

According to embodiments, a service provider can be contemporaneously matched with multiple service requests. In the context of a transport service, the service provider can be matched with multiple transport service requests to provide transport services for multiple users such that at least a portion of the users' trips overlap (e.g., a ride pooling service). For instance, the service provider can travel to rendezvous with and pick up a first user, then travel to rendezvous with and pick up a second user, and then travel to drop off the first and second users. In other examples, the service provider can be matched with a second service request of a second user while in-progress in fulfilling a first service request of a first user (e.g., the service provider is to drop off the first user and then travel to rendezvous with and pick up the second user). Similarly, the service provider can be matched with multiple delivery requests to provide delivery service for multiple requesting users. In certain implementations, the service provider can further be contemporaneously matched with one or more transport requests and one or more delivery requests.

In facilitating the service provider to fulfill one or more matched service requests, the network system can determine a service plan. The service plan can indicate an ordered sequence of service locations for the service provider. In the context of a single service request, the service plan can simply comprise a start location associated with the service request (e.g., a location for the service provider to rendezvous with and pick up the user, an entity location where the service provider is to pick up one or more requested items, etc.) and a destination location associated with the service request (e.g., a location where the service provider is to drop off the requesting user or the one or more requested items). When the service provider is contemporaneously matched with multiple service requests, the service plan determination can indicate an ordered sequence of service locations associated with the matched service requests to which the service provider is to travel. For instance, based on optimizing for reducing total travel time and/or other factors, the network system can determine that, to fulfill a first service request (e.g., a request for a ride pool transport service) of a first user and a second service request of a second user, the service plan comprises an ordered sequence of: (i) a first start location associated with the first service request, (ii) a second start location associated with the second service request, (iii) a second service location associated with the second service request, and (iv) a first service location associated with the first service request.

According to embodiments, the network system can be configured to dynamically update the service plan of a service provider, including updating the ordered sequence of geographic locations associated with multiple service requests matched with the service provider, in response to detecting one or more events (e.g., a service plan update event). For instance, the service plan update event can correspond to a re-route event in which the service provider's navigation route is modified. Depending on the particular circumstances, the modification of the service provider's navigation route can be triggered by the service provider veering off the navigation route and/or updated traffic data indicating heavy traffic on the service provider's navigation route. As another example, the service plan update event can correspond to a service event in which a status or estimated time related to a task related to fulfilling one or more of the service requests matched with the service provider is updated. For example, the service event can be an update from an entity indicating a delay of an estimated time the requested items to be picked up at the entity will be ready for pickup. Thus, in this manner, the network system can communicate with various data sources such as location data generated by the service provider device, traffic data, status data transmitted by computing systems associated with entities, etc., to monitor for events (e.g., re-route events, service event, etc.) to trigger updating the service plan, including updating the ordered sequence of geographic locations. In other examples, the network system can be configured to communicate with the various data sources to monitor for events (e.g., service status or service update) to trigger re-matching of the service requests.

Depending on the implementation, the network system can update the service plan and/or determine whether to update the service plan based on one or more service constraints associated with the requests matched with the service provider. For instance, a service constraint can relate to a class or type of transport service that is requested (e.g., whether the request is for exclusive occupancy of the service provider's vehicle or whether the request is for a ride pool transport), a time constraint associated with the service (e.g., an ETA time constraint at a start location or destination location, a time constraint associated with items for delivery, etc.). In certain situations, the network system can determine to not update the service plan if the modifications to the service plan would cause the fulfillment of the service would violate any of the one or more service constraints.

According to embodiments, the network system can further communicate with the provider device of the service provider to cause the provider device to present one or more notifications regarding the modification of the service plan. The network system can further cause notifications to be presented on the user devices of the requesting users.

As used herein, the terms “optimize,” “optimization,” “optimizing,” and the like are not intended to be restricted or limited to processes that achieve the most optimal outcomes. Rather, these terms encompass technological processes (e.g., heuristics, stochastics modeling, machine learning, reinforced learning, Monte Carlo methods, Markov decision processes, etc.) that aim to achieve desirable results. Similarly, terms such as “minimize” and “maximize” are not intended to be restricted or limited to processes or results that achieve the absolute minimum or absolute maximum possible values of a metric, parameter, or variable.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Descriptions

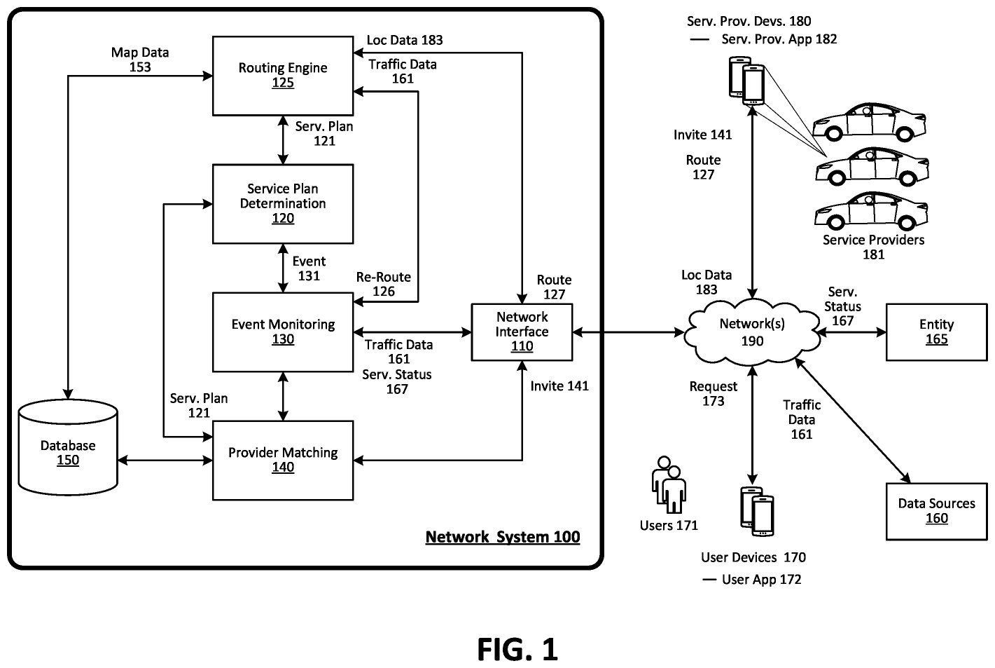

FIG. 1 is a block diagram illustrating an example network system managing a network-based service, in accordance with examples described herein. The network system 100 can implement and manage a network service that connects requesting users 171 with service providers 181 that are available to service the users' requests for service 171. The network service can provide a platform that facilitates services to be requested and provided between requesting users 171 and available service providers 181 by way of a user application 172 executing on the user devices 170 and a service provider application 182 executing on the service provider devices 180. As used herein, a user device 170 and a service provider device 180 can correspond to a computing device with functionality to execute a designated application (e.g., a user application, a provider application, etc.) associated with the network service managed by the network system 100. According to embodiments, the user device 170 and the service provider device 180 can correspond to mobile computing devices, such as smartphones, tablet computers, VR or AR headsets, on-board computing systems of vehicles, smart watches, and the like. Service providers 181 are illustrated as operating motor vehicles in FIG. 1. However, it is understood that the service providers 181 can fulfill the requests 173, particularly requests for a delivery service, in various manners including using micro-mobility means (e.g., bicycles, mopeds, scooters, etc.) and/or without operating a vehicle.

The network system 100 can include a network interface 110 to communicate with user devices 170 and service provider devices 180 over one or more networks 190 via the designated applications (e.g., user application 172, service provider application 182, etc.) executing on the devices. According to examples, a requesting user 171 wishing to utilize the network service can launch the user application 172 and transmit a request for service (e.g., request 173) over network 190 to the network system 100. In certain implementations, the requesting user 171 can view multiple different service types managed by the network system 100, such as ride-pooling, a basic or economy service type, a luxury vehicle service type, a van or large vehicle service type, a professional service provider service (e.g., in which the service providers are certified), a self-driving vehicle service, a rickshaw service, and the like. The network system 100 can utilize the service provider locations to provide the user devices 170 with ETA data of proximate service providers for each respective service. For example, the user application 172 can enable the user 171 to scroll through each service type. In response to a soft selection of a particular service type, the network system 100 can provide ETA data on a user interface of the user application 172 that indicates an ETA for the service type and/or the locations of all proximate available vehicles for that service type. As the user scrolls through each service type, the user interface can update to show visual representations of vehicles for that service type on a map centered around the user 171 or a start location set by the user. The user can interact with the user interface of the user application 172 to select a particular service type, and transmit a request 173.

According to embodiments, the network system 100 further includes provider matching 140 to match users with service providers. At a high level, available service providers 181 can be matched with requesting users 171 based on their respective locations. The matching can be performed based on one or more multi-variate optimizations to, for example, minimize the wait times for users, minimize the distance travelled by service providers to rendezvous with users, etc. In some implementations, the provider matching 140 can determine optimal user-to-provider pairings based on a group optimization of computed matching parameters. In this manner, provider matching can perform group matching to optimize one or more matching parameters across a group of requesting users and a group of service providers. In one implementation, the provider matching 140 can resolve one or more bipartite graphs to select the optimal user-to-provider pairings. In response to a transport service provider 181 being matched to fulfill a request 176, an invitation 141 can be transmitted to the provider device 180 of the transport service provider 181. The invitation 141 can cause the provider device 180 to present a user interface for the transport service provider 181 to accept or decline the invitation 141. If the matched transport service provider 181 declines the invitation 141, the provider matching 140 can re-perform matching.

The network system 100 can further include a service plan determination 120 to generate service plans for service providers. A service plan can include an ordered sequence of service locations (e.g., start location of a request, drop off location, etc.) for the service provider to fulfill a request. Depending on the circumstances, a service plan can be generated for a single service request and can simply include the start location of the request (e.g., pickup location of a transport request) and the destination location of the request (e.g., drop off location of the transport request). A complex service plan that involves multiple requests can be generated for when a service provider is contemporaneously matched with multiple service requests. The service plan for a service provider to fulfill one or more requests for service can be determined during the provider matching process (e.g., prior to matching the service provider with the one or more requests). Depending on the implementation, the provider matching 140 can receive service plans 121 of each potential pairing of service provider and service requester to determine the optimal matching between available service providers and service requests. In addition, for a complex service plan, the service plan determination 120 and/or the provider matching 140 can select one of a plurality of possible service plans based on optimizing a set of service parameters.

After the service provider accepts the invitation to fulfill the request(s), the network system can generate a route of navigation 127 for the service provider 181. The routing engine can pull map data 153 from a database maintained by the network system to generate the route 127 based on the service plan 121 for the service provider 181. For example, the service plan 121 can indicate a sequenced order of service locations for the service provider to travel to in fulfilling the service request(s) matched with the service provider. The routing engine 125 generate the route 127 that navigates the service providers from one location within the service plan 121 to the next location within the service plan 121. The route 127 can also be generated based on traffic data 161 received from a third-party data source 160.

While the service provider is en-route or in-progress to fulfill the request(s), event monitoring 130 of the network system can communicate with various data sources to monitor for and detect service plan update events. A service plan update event can be detected based on data including one or more of, for example, a re-route indication 126 generated by the routing engine 125, location data 183 generated by the provider device 180, traffic data 161 received from the third-party data source 160, and a service status received from an entity 165. At a high-level, a service plan update event can correspond to the re-routing of the service provider in response to the service provider veering off the route 127 determined for the service provider or in response to live traffic data 161 that prompts the routing engine 125 to generate an updated route for the service provider 182. In addition or as an alternative, the network system 100 can communicate with a plurality of provider devices operated by a plurality of service providers in the geographic region and determined, based on the location data generated by the plurality of provider devices, a traffic condition along the route 127 of the service provider 181. In response to a determination of the traffic condition, the routing engine 125 can re-route the service provider 181, which can be detected as a service plan update event.

The service plan update event can also correspond to a service status update. For example, in the context of a ride pool transport service, a requesting user can be informed of a time to arrive at the start location of the request (e.g., the ride pool pickup location) to rendezvous with the service provider. The ride pool user can also be notified that the service provider will wait a predetermined amount of time (e.g., two minutes) at the start location. In the event that the user does not rendezvous with the service provider at the start location by the expiration of the predetermined wait time, the request can be cancelled and the service provider will depart the start location without the user. This is an undesirable experience for the user and leads to suboptimal routing and inefficiencies for the service provider. Embodiments described herein provides that the user can indicate via the user application executing on the user device that the user will be late in arriving at the start location. As an alternative, the user can request to delay the rendezvous time with the service provider or alter the start location where the user is to rendezvous with the service provider. These types of inputs or indications from the user device can be a service status 167 that causes the event monitoring 130 to determine that a service plan update event has occurred. In response, the network system 100 (and service plan determination 120 in particular) can determine if the service plan 121 can be updated in response to mitigate the effects of the user being late to arrive at the start location. For instance, the service provider can rendezvous with another nearby ride pool user first to reduce the amount of time waiting for the late user and/or to avoid cancelling the late rider's request altogether. In the context of a delivery service, the service status 167 can be received from an entity 165 such as a restaurant, a vendor, or provider of items to be delivered. The entity 165 illustrated in FIG. 1 can correspond to a computing system provisioned by the entity (e.g., a tablet computer, a sales terminal computer, etc.). The service status 167 can correspond to an update relating to the status of preparation of the items to be provisioned by the entity. In this manner, the event monitoring 130 can monitor the status of the items to be picked up by the service provider and in response to a determination that the preparation of items are delayed, an event signal 131 can be generated indicating that a service plan update event has been detected. In response, the network system 100 can update the service plan 121 of the service provider.

In addition, the event monitoring 130 can, for example, monitor for a re-route indication 126 generated by the routing engine 125 that indicates that the service provider has been re-routed. As one example, the routing engine 125 can continuously monitor the location data 183 generated by the provider device 180 to track the location of the service provider 181 relative to the route 127 determined for the service provider 181. If the service provider 181 veers off the route 127, a new route can be generated to continuously guide the service provider 182 towards the next service location. The service provider 181 can also be re-routed based live traffic conditions along the route 127. And in certain implementations (e.g., locations where network data connections are not reliable or strong), routing can be performed at least partially offline by the provider device 180. In such implementations, the re-route signal 126 can be generated by the provider device 180 in response to the service provider veering off route. The re-routing of the service provider by the routing engine 125 can cause a re-route signal 126 to be generated by the routing engine 125. The re-route signal 126 can be received by the event monitoring 130.

The service plan determination 120 can update the service plan 121 in response to the event signal 131 generated by event monitoring 130. The service plan 121 can be updated if one or more metrics relating to the service provider's 180 fulfillment of the requests matched with the service provider 180 can be improved as compared to the initial service plan 121. For instance, if an aggregate measure of service time between the users being serviced by the service provider (e.g., total or average time to completion of requested services, total or average wait time, etc.) can be improved by updating the service plan 121, the service plan determination 120 can update the service plan 121. The updating of the service plan 121 can trigger the routing engine 125 to update the route 127 to reflect the updated service plan 121. Furthermore, in response to the service plan 121 being updated, the network system 100 to transmit one or more notifications to the provider device 180 and/or the user device 170 to inform the service provider and/or the user 170 that the service plan 121 and the route 127 have been updated.

### EXAMPLES

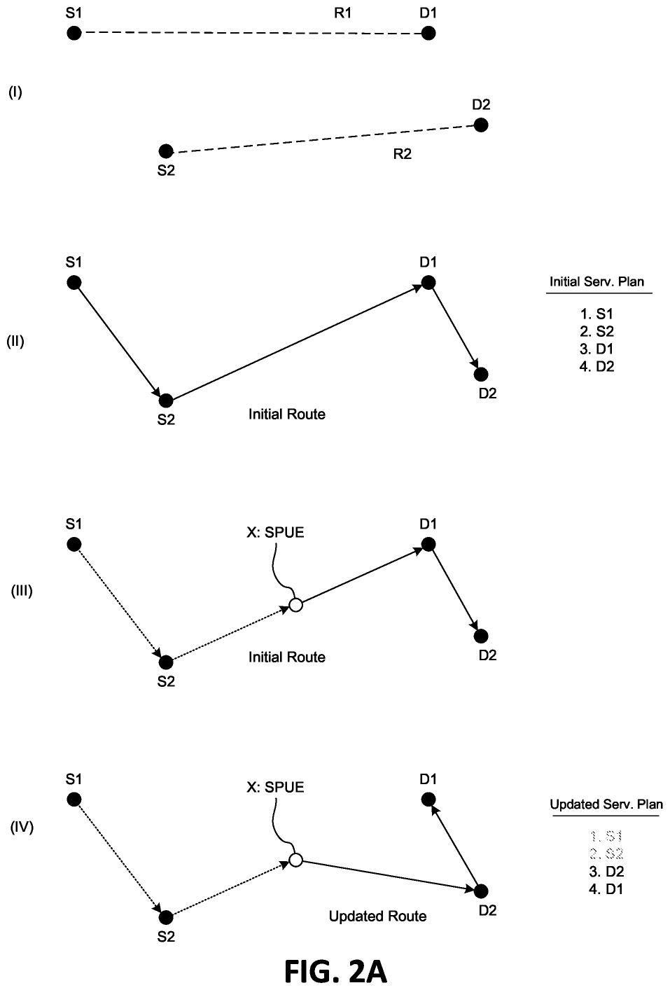

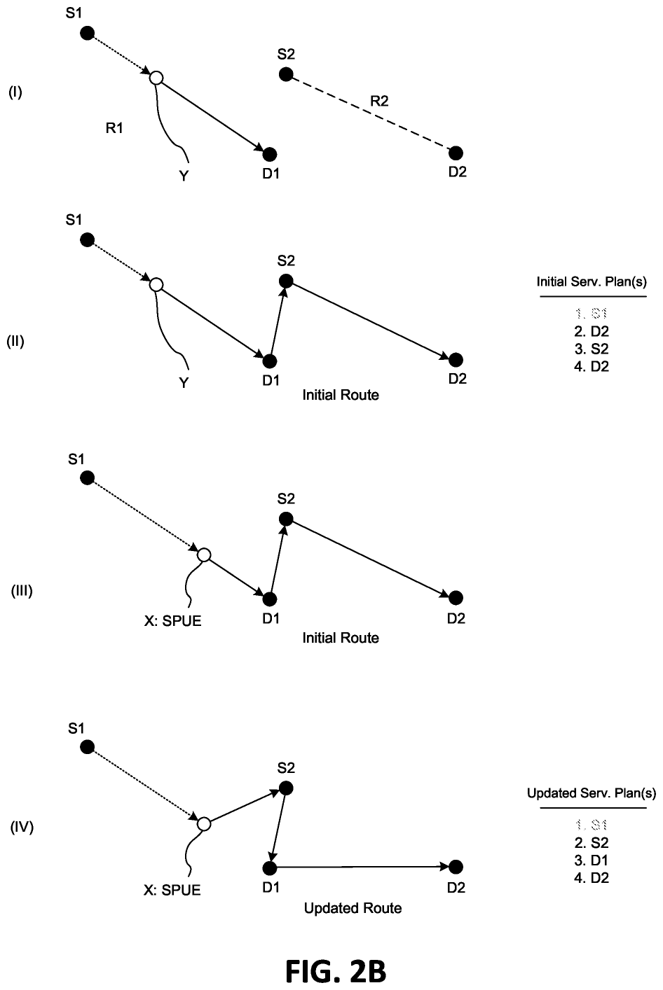

FIG. 2A to 2B illustrate examples for dynamically updating service plans and routes in response to detecting service plan update events, in accordance with the examples described herein. In the below discussion of FIGS. 2A to 2B, reference may be made to features and examples shown and described with respect to FIG. 1. The updating of service plans and routes in response to detecting service plan update events can be performed by the exemplary network system illustrated in FIG. 1.

Referring to FIG. 2A, diagrams I through IV of FIG. 2A illustrate an example in which a service provider is contemporaneously matched to two requests submitted by two users and the service plan/route determined for the service provider includes a shared route segment.

In diagram (I) of FIG. 2A, In FIG. 2, four points are illustrated, each representing a geographic location relating to a service request of a network-based service. For example, a first request (R1) can be a request of a first user for service from a first start location (S1) to a first destination location (D1) and a second request (R2) can be a request for service from a second start location (S2) to a second destination location (D2). According to embodiments, R1 and R2 can correspond to requests for an app-based transport service and/or an app-based delivery service. For instance, R1 can be a request for a transport service to rendezvous and pick up a first user at S1 and drop off the first user at D1. R1 can also be a request for a delivery service to pick up one or more items at S1 and drop off the one or more items at D1 (e.g., delivery location). The same can be true for the second request (R2).

Diagram (II) of FIG. 2A illustrates an initial service plan for the service provider to fulfill the two requests R1 and R2. The initial service plan can be determined by the network system based on optimizing one or more service parameters including, for example, estimated times of arrival of the service provider at the various service locations, wait times of the users, total distance traveled by the service provider in fulfilling the two service requests, and the like. The initial service plan can include an ordered sequence of service locations relating to R1 and R2. According to the initial service plan illustrated in Diagram (II), the service provider is to travel to location S1, then travel to location S2, then travel to location D1, and finally travel to location D2. Moreover, the initial route of the service provider can be generated by network system based on the initial service plan and can include a first route segment from a current location of the service provider to S1, a second route segment from S1 to S2, a third route segment from S2 to D1, and a fourth route segment from D1 to D2. While not illustrated in FIG. 2A, the initial service plan can further specify one or more actions the service provider is to perform at each of the service locations. For instance, at location S1, the initial service plan can specify that the service provider is to rendezvous with and pick up the first user for a transport request or pick up one or more items requested by the first user for a delivery request.

In certain implementations, the initial service plan can be determined during the matching process to match available service providers with service requests and the identification of the service provider as an appropriate match for the requests R1 and R2 (out of the plurality of available service providers) can be based on the service parameters computed for the initial service plan, as compared to hypothetical service plans generated for the other available service providers (e.g., to minimize wait times or arrival times, to minimize total distance traveled by the service provider, etc.).

In Diagram (III) of FIG. 2A, a service plan update event (SPUE) is illustrated to be detected while the service provider navigates along the initial route (at location X), in particular on the route segment between S2 and D1. As described herein, the service plan update event can be a re-route event triggered in response to the service provider veering off the initial route determined by the network system (e.g., taking a wrong turn, missing a turn, or otherwise failing to follow the turn-by-turn navigation directions presented on the provider device) or triggered in response to receipt of updated traffic data pertaining to the roads or freeways along the remainder of the initial route.

In certain situations, the re-routing of the service provider off the initial route due to, for example, a wrong turn taken by the service provider or based on live traffic data, can result in suboptimal routing for the service provider in fulfilling the first and second service requests, particularly in dense urban environments where one-way streets are common. Accordingly, the network system can determine whether to re-order the service locations in the initial service plan of the service provider in response to the re-routing of the service provider to achieve a more desirable routing for the service provider in fulfilling the first and second service requests. The network system can

Diagram (IV) of FIG. 2A illustrates an updated service plan that is generated in response to the detection of the service plan update event. In the updated service plan, the sequenced order of service locations can be different compared to the initial service plan. For instance, the order of locations D2 and D1 can be swapped in comparison to the initial service plan. Thus, rather than traveling to location D1 from location X, where the service provider was located when service plan update event was detected, to fulfill request R1 and then continuing to location D2, as specified by the initial service plan, the updated service plan can call for the service provider to travel to location D2 to completed request R2 prior to traveling to location D1 to complete request R2. An updated route can be generated by the network system that includes a route segment from location X to location D2 and a second route segment from location D2 to location D1.

According to embodiments, in response to the updated service plan and/or the updated route being generated, the network system can communicate with the provider device of the service provider to cause the provider device to present a notification or prompt notifying the service provider of the update to the service plan and/or the route for the service provider. For instance, the notification can inform the service provider that the order of the service locations D1 and D2 within the service plan has been modified (e.g., location D2 to be visited by the service provider prior to location D1). In addition, the notification can inform the service provider the reason(s) why the modification to the service plan occurred (e.g., change in route, etc.). In some instances, the network system can further cause notification(s) to be presented on user devices of the first user and the second user. For example, in the example of a ride pool transport service, the first user can access the user application executing on a first user device of the first user to view the portions of the route of the service provider that are relevant to the request of the first user (e.g., to view the route of the service provider from location S1 to location S2 to location D1 in accordance with the initial service plan/route). Similarly, the second user can access the user application executing on a second user device of the second user to view the portions of the route of the service provider that are relevant to the request of the second user (e.g., to view the route of the service provider from location S2 to location D1 to location D2 in accordance with the initial service plan/route). In response to the updated service plan and/or the updated route being generated, a first notification can be presented on the first user device of the first user to inform the first user that, in accordance with the updated service plan, the route of the service provider has been modified and that the service provider will drop off the second user at location D2 prior to dropping off the first user at location D1. Similarly, a second notification can be presented on the second user device of the second user to inform the second user of the same. In certain implementations, notifications provided on the provider device, the first user device, and/or the second user device can be interactive such that the service provider, the first user, and/or the second user can accept or decline the service plan update. For instance, if the service provider declines the service plan update, the network system can continue to facilitate the service provider in accordance with the initial service plan.

Referring to FIG. 2B, Diagrams (I) through (IV) of FIG. 2B illustrate another example in which a service provider is contemporaneously matched to two requests submitted by two users. In particular, while the service provider is in-progress of completing a first request of a first user, the service provider is matched with a second request of a second user such that the service provider is to first complete the first service request before proceeding to fulfill the second service request. By matching a service provider that is in-progress of fulfilling the first request with a second request to be fulfilled after fulfillment of the first request, the network system can improve efficiencies and decrease downtime for service providers.

Diagram (I) of FIG. 2B illustrates a service provider that is en-route and in-progress of fulfilling a first request R1 from a first start location S1 to a first destination location D1. In the example illustrated in Diagram (I), the service provider is at location Y while en-route between location S1 and location D1 when the network system identifies the service provider as an appropriate match for a second request R2 requesting service from a second start location S2 to a second destination location D2. The service provider can be identified as an appropriate match for request R2 while in-progress of fulfilling request R1 because location D1 is located within a short distance or ETA of location S2 and the network system estimates that the service provider will arrive at location S2 an optimal time to rendezvous with the second user after completing the first request R1 at location D1.

Diagram (II) of FIG. 2B illustrates an initial service plan for the service provider to fulfill the two requests R1 and R2. Depending on the implementation, the network system can create two service plans for the service provider to fulfill the requests R1 and R2—one for request R1 and another for request R2. According to the initial service plan, the service provider is to first travel from its current location to D1 to complete request R1, then to S2 (e.g., to rendezvous with and pick up the second user for a transport request or to pick up one or more items for delivery for a delivery request, etc.), and finally to D2 to complete request R2. An initial route can also be created based on the initial service plan. And the initial route can include a first route segment to D1, a second route segment to S2, and a third route segment to D2.

In Diagram (III) of FIG. 2B, a service plan update event (SPUE) is illustrated to be detected while the service provider navigates along the initial route (at location X), in particular on the route segment to D1.

Diagram (IV) of FIG. 2B illustrates an updated service plan that is generated in response to the detection of the service plan update event. In the updated service plan, the sequenced order of service locations can be different compared to the initial service plan. For instance, the order of locations S2 and D1 can be swapped in comparison to the initial service plan. Depending on the implementation, the network system can further combine two distinct service plans (e.g., one for fulfillment of request R1 and another for fulfillment of request R2) to generate a single service plan in response to the detection of the service plan update event. In the updated service plan, the service provider to travel to location S2 to begin fulfillment of the second request R2 prior to traveling to location D1 to complete the first request R1. In the updated service plan, the fulfillment of the first and second requests R1 and R2 share a route segment from S2 to D1. In comparison, in the initial service plan, the fulfillment of the first and second requests R1 and R2 do not share any route segments.

In the example illustrated in FIG. 2B, updating service plan in response to detecting the service plan update event can be further based on whether the updated service plan reduces an aggregate measure of one or more service parameters for the first and second users (e.g., aggregate time to travel to D1 and D2 to fulfill the requests R1 and R2, total distance traveled by the service provider in fulfilling the requests R1 and R2, etc.) in comparison to the initial service plan. For instance, in response to detecting the service plan update event (e.g., re-route event triggered by the service provider taking a wrong turn or based on live traffic data), the network system can determine that updating the service plan such that the service provider travels to S2 and begin the fulfillment of request R2 of the second user prior to traveling to D1 to complete the request R1 of the first user reduces an aggregate measure of service time for the requests R1 and R2. And in response, the network system can update the initial service plan.

The determination to update the service plan for the service provider as illustrated in FIG. 2B can also be dependent on various service constraints. In the context of a transport service, the service constraints can relate to a transport service class or type. For instance, if both requests R1 and R2 are requests for a ride pool transport service class in which the first and second requesters consent to sharing occupancy of the transport vehicle with other users of the transport service, the network system can determine to update the service plan as illustrated in FIG. 2B in response to detecting the service plan update event. If either request R1 or request R2 is a request for a standard transport class in which the user does not consent to sharing occupancy of the transport vehicle with other users of the transport service, the network system can determine not to update the service plan in response to detecting the service plan update event and maintain the initial service plan even though the service plan update event was detected. In addition or as an alternative, the service constraints can include an estimated time of arrival (ETA) for the first user at location D1. For instance, if updating the service plan will cause the ETA of the first user at D1 to exceed a threshold value compared to proceeding in accordance with the initial service plan or compared to an initial ETA for the first user, the network system can determine to proceed in accordance with the initial service plan even though the service plan update event was detected. Similarly, in the context of a delivery service, the service constraints can include an arrival time constraint for the request R1 at location D1. For example, the request R1 can be associated with a time constraint (e.g., a food freshness time constraint in the context of a food delivery) and the network system can selectively determine to update the service plan based on whether the updated route for the updated service plan will enable the service provider to fulfill the first request R1 at location D1 within the time constraint.

### Methodology

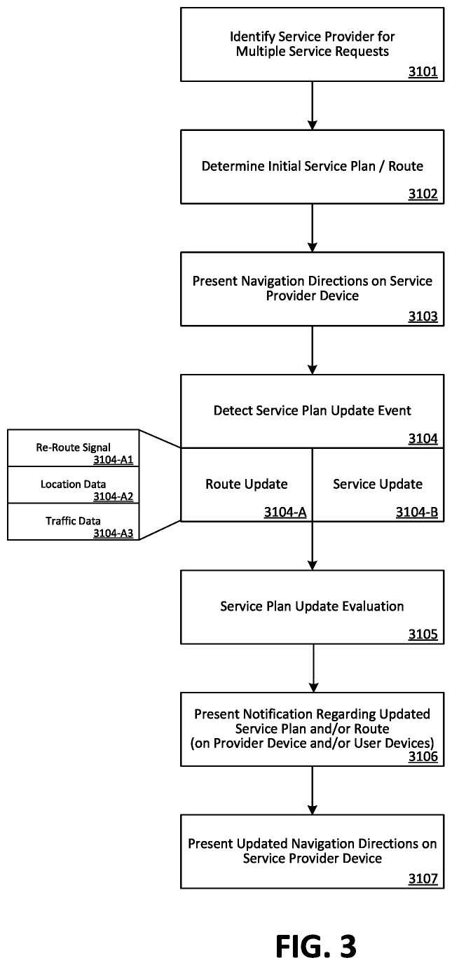

FIG. 3 is a flowchart diagram illustrating an example method of dynamically updating a service plan in response to detected events, in accordance with examples described herein. In the below discussion of FIG. 3, reference may be made to features and examples shown and described with respect to FIG. 1. For instance, the method 3000 illustrated in and described with respect to FIG. 3 can be performed by the exemplary network system illustrated in FIG. 1.

At step 3101, the network system can identify a service provider for multiple service requests. The network system can contemporaneously match the service provider to fulfill multiple requests for service (e.g., transport requests and/or delivery requests). In certain variations, the network system can contemporaneously match the service provider with multiple requests for service such that the fulfillment of two or more requests share occupancy of the transport vehicle or share a route segment. For instance, two pool riders can share occupancy of the transport vehicle for at least a portion of the route of the service provider in fulfilling the requests of the two riders. Similarly, the service provider can pick up items for two delivery orders by two delivery requesters. An example of such situations is illustrated in FIG. 2A. In other variations, the network system can contemporaneously match the service providers with multiple requests by matching the service provider with a second request while the service provider is en-route or in-progress of fulfilling a first request, the fulfillment of the second request to begin after completing fulfillment of the first request. An example of such scenarios is illustrated in Diagrams (I) and (II) of FIG. 2B.

At step 3102, the network system determines an initial service plan(s) and route for the service provider in fulfilling the multiple service requests. The initial service plan can include or indicate an initial order of service locations associated with the multiple service requests. The initial order of service locations can be determined based at least in part on one or more optimization parameters associated with the multiple service requests. As part of the determination of the order of service locations, the network system can also determine a navigation route for the service provider to follow in fulfilling the multiple service requests. At step 3103, the provider device can present a set of navigation directions (e.g., turn-by-turn navigation directions) that correspond to the service route. The network system can transmit a set of data (e.g., route display data, navigation route data, etc.) to cause the provider device to present the route and/or the navigation directions.

At step 3104, the network system can detect a service plan update event. The network system can continuously communicate with the provider device and/or other data sources to detect the service plan update event.

At step 3105, the network system can perform a service plan update evaluation to determine whether to update the initial service plan of the service provider in response to the detection of the service plan update event. The service plan update evaluation can determine an updated order of service locations for the service provider in fulfilling multiple service requests. Depending on the implementation, the network system can determine a number of alternative service plans (e.g., each having a different possible permutation of service location orders or rankings) and compute or estimate a set of service parameters for each of the alternative service plans. For example, an estimated service

At step 3106, the network system can cause notifications regarding the update to be presented on the provider device of the service provider and/or the user devices of the users of the requests being fulfilled by the service provider. The notifications can be triggered to be presented on the provider and/or user devices in response to the network system determining to update the service plan for the service provider. The notifications can be a push notification and/or an in-app notification presented within the provider application and/or the user application. The notifications can include information relating to the changes to the service plan. For instance, a notification presented on the provider device can inform the service provider that the ordering of the service locations to be visited by the service provider in fulfilling multiple service requests has been modified. The notification can further provide information relating to the next task the service provider is to perform at the next service location according to the updated service plan. The notification can inform the service provider what the next service location is in the updated service plan, what task the service provider is to perform at the next service location (e.g., rendezvous with and pick up a rider, drop off a rider, pick up items for delivery from a restaurant or vendor, drop off items for delivery, etc.), and the route the service provider is to take to travel to the next service location. Similar notifications can be presented on the user devices.

At step 3107, the network system can present updated navigation directions to guide the service provider to the next service location in accordance with the updated service plan.

### Hardware Diagrams

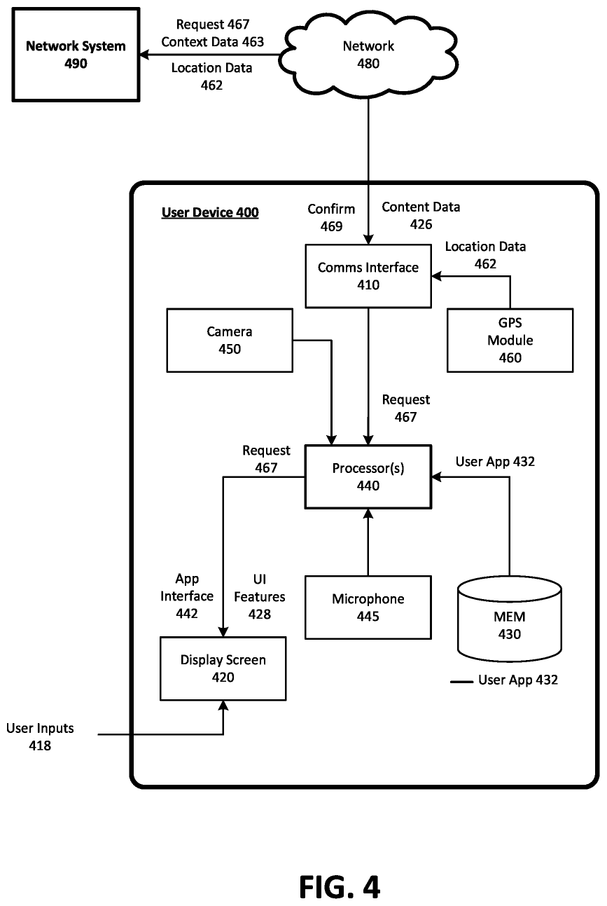

FIG. 4 is a block diagram illustrating an example user device executing and operating a designated user application for communicating with a network system, according to examples described herein. In many implementations, the user device 400 can comprise a mobile computing device, such as a smartphone, tablet computer, laptop computer, VR or AR headset device, and the like. As such, the user device 400 can include typical telephony features such as a microphone 445, a camera 450, and a communication interface 410 to communicate with external entities using any number of wireless communication protocols. In certain aspects, the user device 400 can store a designated application (e.g., a user application 432) in a local memory 430. In variations, the memory 430 can store additional applications executable by one or more processors 440 of the user device 400, enabling access and interaction with one or more host servers over one or more networks 480.

In response to a user input 418, the user application 432 can be executed by a processor 440, which can cause an application interface 442 to be generated on a display screen 420 of the user device 400. The application interface 442 can enable the user to, for example, check current value levels and availability for the network service. In various implementations, the application interface 442 can further enable the user to select from multiple service types.

The user can generate a service request 467 via user inputs 418 provided on the application interface 442. For example, the user can select a start location, view the various service types and estimated costs, and select a particular service to an inputted destination. In many examples, the user can input the destination prior to pick-up. As provided herein, the user application 432 can further enable a communication link with a network system 490 over the network 480, such as the network system 100 as shown and described with respect to FIG. 1. The processor 440 can generate user interface features 428 (e.g., map, trip progress bar, content cards, etc.) using content data 426 received from the network system 490 over network 480. Furthermore, as discussed herein, the user application 432 can enable the network system 490 to cause the generated user interface features 428 to be displayed on the application interface 442.

The processor 440 can transmit the service requests 467 via a communications interface 410 to the backend network system 490 over a network 480. In response, the user device 400 can receive a confirmation 469 from the network system 490 indicating the selected service provider and vehicle that will fulfill the service request 467 and rendezvous with the user at the start location. In various examples, the user device 400 can further include a GPS module 460, which can provide location data 462 indicating the current location of the requesting user to the network system 490 to, for example, establish the start location and/or select an optimal service provider or autonomous vehicle to service the request 467.

In certain implementations, the user device 400 is configured to generate and transmit, to the network system 490, context data 463 that can be used by the network system to determine a propensity of the user who operates the user device 400 to perform an action via the user application 432. The context data 463 can include user application interaction data indicating interactions, inputs, selections, or a degree of progress through a particular user interface flow (e.g., a user interface flow to submit a service request). The context data 463 can further include sensor data such as barometer or elevation data, ambient light sensor data, accelerometer data, gyroscope data, location data 462, and the like. The context data 463 can further include user application status data indicating, for example, whether the user application 432 is executing as a background process or as a foreground process on the user device 400. The user application status data can further indicate a duration of time the user application 432 has been executing as a foreground process or a duration of time the user application 432 has been executing as a background process. Using the context data 463, the network system 490 can determine, using one or more context models, a propensity of the user to, for example, submit a service request within the next 2 minutes, or cancel a submitted service request 467 once the user is matched by the network system 490 with a service provider in response to the service request 467.

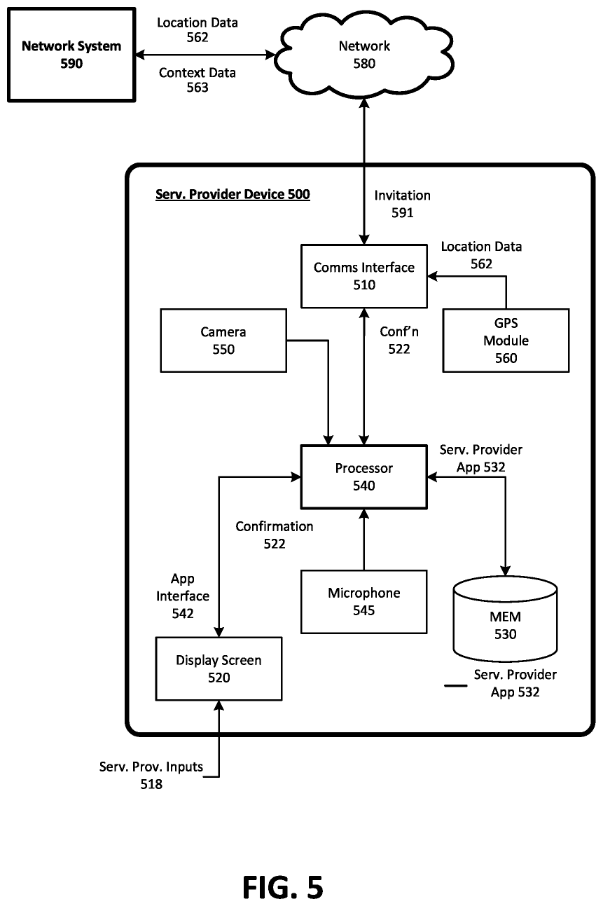

FIG. 5 is a block diagram illustrating an example service provider device executing and operating a designated service provider application for communicating with a network service, according to examples described herein. In many implementations, the service provider device 500 can comprise a mobile computing device, such as a smartphone, tablet computer, laptop computer, VR or AR headset device, and the like. As such, the service provider device 500 can include typical telephony features such as a microphone 545, a camera 550, and a communication interface 510 to communicate with external entities using any number of wireless communication protocols. The service provider device 500 can store a designated application (e.g., a service provider app 532) in a local memory 530. In response to a service provider input 518, the service provider app 532 can be executed by a processor 540, which can cause an app interface 542 to be generated on a display screen 520 of the service provider device 500. The app interface 542 can enable the service provider to, for example, accept or reject invitations 592 in order to service requests throughout a given region.

In certain implementations, the service provider device 500 is configured to generate and transmit, to the network system 590, context data 563 that can be used by the network system to determine a propensity of the service provider who operates the service provider device 500 to perform an action via the service provider application 532. The context data 563 can include service provider application interaction data indicating interactions or inputs of the service provider with the service provider application 532. The context data 563 can further include sensor data such accelerometer data, gyroscope data, e-compass data, and the like. In certain implementations, the network system 590 can further utilize location data 562 as context data in making certain determinations. Using the context data 563, the network system 590 can determine, using one or more context models, a propensity of the service provider to, for example, decline an invitation corresponding to a service request form a user or cancel an acceptance after the service provider has accepted the invitation.

In various examples, the service provider device 500 can include a GPS module 560, which can provide location data 562 indicating the current location of the service provider to the network system 590 over a network 580. The network system 590 can determine whether the service provider operating service provider device 500 is a suitable match for a particular request. In this determination, the network system 590 can compute a matching parameter for the service provider based on the location data 562 and other data, including context data 563, which can be a predictive indicator of how suitable the service provider is for fulfilling a particular service request. Furthermore, in determining whether the service provider should be matched with the particular request, the network system 590 can determine a mode of operation (e.g., exclusive-invite mode vs. multi-invite mode) and a presentation mode for presenting information relating to the invitation and/or the request (e.g., an active multi-invite presentation vs. a passive multi-invite presentation mode).

In response to the service provider being determined as a match for the particular request (e.g., either an exclusive match in the exclusive-invite mode or one of a plurality of matches in the multi-invite mode), the network system 590 transmits an invitation 591 relating to the particular request to the service provider device 500. In response to receiving the invitation 591, the service provider device 500 can present information relating to the invitation 591 and/or the particular request on the display screen 520. Receipt of the invitation 591 can also trigger an audio notification. The information relating to the invitation and/or particular request can be presented in accordance to the determined mode of operation and/or the presentation mode. In some implementations, the information can be presented in distinct manners based on (i) the invitation 591 being an exclusive-mode invitation, (ii) the mode of presentation of the invitation 591 being determined for the service provider as the active multi-invite presentation mode, and/or (iii) the mode of presentation of the invitation 591 being determined for the service provider as the passive multi-invite presentation mode. The service provider can interact with the service provider application 532 to accept or decline the invitation 591.

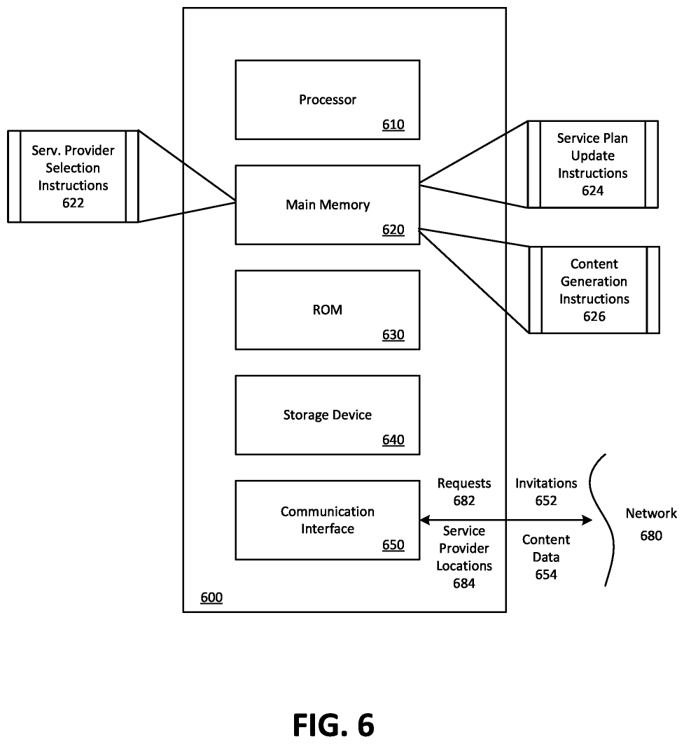

FIG. 6 is a block diagram that illustrates a computer system upon which examples described herein may be implemented. A computer system 600 can be implemented on, for example, a server or combination of servers. For example, the computer system 600 may be implemented as part of a network service, such as described in FIGS. 1 through 6. In the context of FIG. 1, the computer system 600 may be implemented using a computer system 600 such as described by FIG. 6. The network system 100 may also be implemented using a combination of multiple computer systems as described in connection with FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks 680 (e.g., cellular network) through use of the network link (wireless or wired). Using the network link, the computer system 600 can communicate with one or more computing devices, one or more servers, and/or one or more self-driving vehicles. In accordance with examples, the computer system 600 receives requests 682 from mobile computing devices of individual users. The executable instructions stored in the memory 630 can include service provider selection instructions 622, which the processor 610 executes to select a service provider to service the request 682. In doing so, the computer system can receive service provider locations 684 of service providers operating throughout the given region, and the processor can execute the service provider selection instructions 622 to identify a plurality of candidate service providers and transmit invitation messages 652 to each of the candidate service providers to enable the service providers to accept or decline the invitations. The processor can further execute the service provider selection instructions 622 to select a service provider among interested candidate service providers to service the request 682.

The executable instructions stored in the memory 620 can also include service plan update instructions 624, which enable the computer system 600 to detect service plan update events and update service plans of service providers in response to detecting the service plan update events. Content generation instructions 626 can enable the computer system 600 to access user profiles and other user information in order to select and/or generate user content 654 for display on the user devices. As described throughout, user content 654 can be generated based on information pertaining to the state of the request (e.g., ETA/destination info). By way of example, the instructions and data stored in the memory 620 can be executed by the processor 610 to implement an example network system 100 of FIG. 1. In performing the operations, the processor 610 can receive requests 682 and service provider locations 684, and submit invitation messages 652 to facilitate the servicing of the requests 682. The processor 610 is configured with software and/or other logic to perform one or more processes, steps and other functions described with implementations, such as described by FIGS. 1 through 3, and elsewhere in the present application.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system for managing a network-based service, the network system comprising:
one or more processors; and
one or more memory resources storing instructions that, when executed by the one or more processors of the network system, cause the network system to:
identify a service provider to fulfill a first service request of a first user and a second service request of a second user;
generate, for the service provider, an initial service plan in which a first service location associated with the first service request of the first user is sequenced prior to a second service location associated with the second service request of the second user;
communicate with a provider device of the service provider to cause the provider device to present a first set of navigation directions corresponding to an initial route associated with the initial service plan, the initial route including a first route segment from the first service location associated with the first service request to the second service location associated with the second service request;
while the service provider is in-progress to fulfill the first service request or the second service request, detect a service plan update event;
in response to detecting a service plan update event, generate an updated service plan in which the second service location associated with the second service request of the second user is sequenced prior to the first service location associated with the first service request of the first user; and
communicate with the provider device to cause the provider device to:
(i) present a notification regarding updating the initial service plan to the updated service plan, and (ii) present a second set of navigation directions corresponding to an updated route associated with the updated service plan, the updated route including a second route segment from the second service location associated with the second service request of the second user to the first service location associated with the first service request of the first user.

2. The network system of claim 1, wherein detecting the service plan update event comprises receiving a re-route signal indicating that initial route of the service provider has been modified.

3. The network system of claim 2, wherein detecting the service plan update event further comprises:
determining, in response to receiving the re-route signal, a first service metric for the initial service plan;
retrieving an alternate service plan for the service provider to fulfill the first service request and the second service request;
determining a second service metric for the alternate service plan; and
based on a comparison between the first service metric and the second service metric, determining that the service plan update event has occurred.

4. The network system of claim 2, wherein the initial route of the service provider is modified in response to one or more of: (i) an off-course indication indicating that the service provider has veered off the initial route, or (ii) traffic data relevant to the initial route of the service provider.

5. The network system of claim 1, wherein detecting the service plan update event comprises communicating with the provider device to receive location data generated by the provider device.

6. The network system of claim 1, wherein detecting the service plan update event comprises communicating with a third-party data source to receive traffic data that is relevant to the initial route of the service provider.

7. The network system of claim 1, wherein detecting the service plan update event comprises communicating with a plurality of service provider devices of a plurality of service providers to determine a traffic condition along the initial route of the service provider.

8. The network system of claim 1, wherein detecting the service plan update comprises receiving, from a user device of the first user, an indication that the first user to late in arriving at the first service location to rendezvous with the service provider.

9. The network system of claim 1, wherein the network service is a delivery service and wherein detecting the service plan update comprises receiving a service update regarding one or more items requested by the first user or the second user.

10. A computer-implemented method of managing a network-based service, the method being performed by a computing system and comprising:
identifying a service provider to fulfill a first service request of a first user and a second service request of a second user;
generating, for the service provider, an initial service plan in which a first service location associated with the first service request of the first user is sequenced prior to a second service location associated with the second service request of the second user;
communicating with a provider device of the service provider to cause the provider device to present a first set of navigation directions corresponding to an initial route associated with the initial service plan, the initial route including a first route segment from the first service location associated with the first service request to the second service location associated with the second service request;
while the service provider is in-progress to fulfill the first service request or the second service request, detecting a service plan update event;
in response to detecting a service plan update event, generating an updated service plan in which the second service location associated with the second service request of the second user is sequenced prior to the first service location associated with the first service request of the first user; and
communicate with the provider device to cause the provider device to: (i) present a notification regarding updating the initial service plan to the updated service plan, and (ii) present a second set of navigation directions corresponding to an updated route associated with the updated service plan, the updated route including a second route segment from the second service location associated with the second service request of the second user to the first service location associated with the first service request of the first user.

11. The computer-implemented method of claim 10, wherein detecting the service plan update event comprises receiving a re-route signal indicating that the initial route of the service provider has been modified.

12. The computer-implemented method of claim 11, wherein detecting the service plan update event further comprises:
determining, in response to receiving the re-route signal, a first service metric for the initial service plan;
retrieving an alternate service plan for the service provider to fulfill the first service request and the second service request;
determining a second service metric for the alternate service plan; and
based on a comparison between the first service metric and the second service metric, determining that the service plan update event has occurred.

13. The computer-implemented method of claim 11, wherein the initial route of the service provider is modified in response to one or more of: (i) an off-course indication indicating that the service provider has veered off the initial route, or (ii) traffic data relevant to the initial route of the service provider.

14. The computer-implemented method of claim 10, wherein detecting the service plan update event comprises communicating with the provider device to receive location data generated by the provider device.

15. The computer-implemented method of claim 10, wherein detecting the service plan update event comprises communicating with a third-party data source to receive traffic data that is relevant to the initial route of the service provider.

16. The computer-implemented method of claim 10, wherein detecting the service plan update event comprises communicating with a plurality of service provider devices of a plurality of service providers to determine a traffic condition along the initial route of the service provider.

17. The computer-implemented method of claim 10, wherein detecting the service plan update comprises receiving, from a user device of the first user, an indication that the first user to late in arriving at the first service location to rendezvous with the service provider.

18. The computer-implemented method of claim 10, wherein the network service is a delivery service and wherein detecting the service plan update comprises receiving a service update regarding one or more items requested by the first user or the second user.

19. A non-transitory computer-readable medium storing instructions that, when executed by one or more processors of a computing system for managing a network-based service, cause the computing system to:
identify a service provider to fulfill a first service request of a first user and a second service request of a second user;
generate, for the service provider, an initial service plan in which a first service location associated with the first service request of the first user is sequenced prior to a second service location associated with the second service request of the second user;
communicate with a provider device of the service provider to cause the provider device to present a first set of navigation directions corresponding to an initial route associated with the initial service plan, the initial route including a first route segment from the first service location associated with the first service request to the second service location associated with the second service request;
while the service provider is in-progress to fulfill the first service request or the second service request, detect a service plan update event;
in response to detecting a service plan update event, generate an updated service plan in which the second service location associated with the second service request of the second user is sequenced prior to the first service location associated with the first service request of the first user; and
communicate with the provider device to cause the provider device to: (i) present a notification regarding updating the initial service plan to the updated service plan, and (ii) present a second set of navigation directions corresponding to an updated route associated with the updated service plan, the updated route including a second route segment from the second service location associated with the second service request of the second user to the first service location associated with the first service request of the first user.

20. The non-transitory computer-readable medium of claim 19, wherein detecting the service plan update event comprises receiving a re-route signal indicating that the initial route of the service provider has been modified.
